(19) United States
(12) Patent Application Publication
(10) Pub. No.: US 2017/0171508 A1
(43) Pub. Date: Jun. 15, 2017

(54) Method and Device for Inputting Audio and Video Information

(71) Applicants: Le Holdings (Beijing) Co., Ltd., Beijing (CN); Le Shi Zhi Xin Electronic Technology (Tianjin) Limited, Beijing (CN)

(72) Inventors: Zhenzhou Pang, Beijing (CN); Hua Kang, Beijing (CN); Xun Xv, Beijing (CN)

(73) Assignees: Le Holdings (Beijing) Co., Ltd., Beijing (CN); Le Shi Zhi Xin Electronic Technology (Tianjin) Limited, Beijing (CN)

(21) Appl. No.: 15/245,958

(22) Filed: Aug. 24, 2016

Related U.S. Application Data
(63) Continuation-in-part of application No. PCT/CN2016/088099, filed on Jul. 1, 2016.

(30) Foreign Application Priority Data
Dec. 15, 2015 (CN) 201510946467.X

(51) Int. Cl. H04N 7/14; G06F 17/30; G06K 19/06

(52) U.S. Cl. CPC H04N 7/141; G06K 19/06037; G06F 17/30879

(57) ABSTRACT

A method and device for inputting audio and video information, wherein the method comprises: when a first terminal is in a video call, starting a relay server of the first terminal and obtaining an address of the relay server; generating a two-dimensional code according to the address, such that the user device starts a browser according to the address in the two-dimensional code; receiving audio and video information sent by the user device and sending the audio and video information to a remote second terminal. The user device may be a video and audio inputting device on the terminal, and transmission of audio and video information between the user device and the terminal ma be realized on the basis of the relay server technology to save the use cost while meeting the requirements of a user for a video resolution and a voice effect.

### CROSS-REFERENCE TO RELATED APPLICATIONS

This application is a continuation-in-part of International Application No. PCT/CN2016/088099, filed on Jul. 1, 2016, which is based upon and claims priority to Chinese Patent Application No. 201510946467.X, filed on Dec. 15, 2015, the entire contents of which are incorporated herein by reference.

### TECHNICAL FIELD

The disclosure relates to the field of smart terminal application, and specifically relate to a method and device for inputting audio and video information, a network television and a user device.

### BACKGROUND

When a user wants to make a multi-screen video call by means of a television, it requires that the television should be provided with audio and video inputting devices. The existing solution is that the user buys extra camera and microphone adaptive to the television as the video and audio inputting devices; the camera and the microphone can be further used only after being inserted into the peripheral jacks of the television.

However, if independent peripherals are bought, the use cost of the user is increased; moreover, the video resolution of a common camera and the voice effect of a common microphone are both unsatisfactory with regard to requirements of a user; for example, the video quality requires that the image quality reaches high definition image quality (e.g., 1080p), and noise reduction, echo removal, gain increase and so on are required for voice processing; the requirements in the two aspects cannot be met by common peripherals.

### SUMMARY

Aiming at the defects in the prior art, embodiments of the present disclosure provide a method and device for inputting audio and video information, a network television and a user device, which are capable of solving the problems in the prior art that the use cost of a user is increased by buying independent peripherals and the video resolution of the common camera and the voice effect of the common microphone are both unsatisfactory with regard to requirements of the user.

In order to solve the above technical problems, the present disclosure provides the following technical solutions:

According to a first aspect, the present invention provides a method for inputting audio and video information, includes:

when a first terminal is in a video call, starting a relay server of the first terminal and obtaining an address of the relay server;

generating a two-dimensional code according to the address, such that a user device starts a browser according to the address in the two-dimensional code to acquire audio and video information;

receiving the audio and video information sent by the user device and sending the audio and video information to a remote second terminal.

According to a second aspect, the present invention provides a method for inputting audio and video information, includes:

when a user device scans a two-dimensional code displayed on a first terminal, starting a browser of the user device, wherein the two-dimensional code includes an address of a relay server of the first terminal;

acquiring audio and video information of the user device by means of the browser;

sending the audio and video information to the first terminal according to the address of the relay server.

According to a third aspect, the present invention also provides an electronic device, including a memory and at least one central processing unit, where the memory is connected to the at least on central processing unit by using a bus, the memory is configured to store a computer instruction, and when the device runs, the at least on central processing units executes the device to execute the following operations: when a first terminal is in a video call, starting a relay server of the first terminal and obtaining an address of the relay server; generating a two-dimensional code according to the address, such that a user device starts a browser according to the address in the two-dimensional code to acquire audio and video information; receiving the audio and video information sent by the user device and sending the audio and video information to a remote second terminal.

According to a fourth aspect, the present invention also provides an electronic device, including a memory and at least one central processing unit, where the memory is connected to the at least on central processing unit by using a bus, the memory is configured to store a computer instruction, and when the device runs, the at least on central processing units executes the device to execute the following operations: when a user device scans a two-dimensional code displayed on a first terminal, starting a browser of the user device, wherein the two-dimensional code includes an address of a relay server of the first terminal; acquiring audio and video information of the user device by means of the browser; sending the audio and video information to the first terminal according to the address of the relay server.

According to a fifth aspect, the present invention provides a non-volatile computer readable storage medium, where the non-volatile computer readable storage medium stores a computer instruction, and a computer executes the computer instruction to execute the following operations: when a first terminal is in a video call, starting a relay server of the first terminal and obtaining an address of the relay server; generating a two-dimensional code according to the address, such that a user device starts a browser according to the address in the two-dimensional code to acquire audio and video information; receiving the audio and video information sent by the user device and sending the audio and video information to a remote second terminal. According to a fifth aspect, the present invention provides a non-volatile computer readable storage medium, where the non-volatile computer readable storage medium stores a computer instruction, and a computer executes the computer instruction to execute the following operations: when a user device scans a two-dimensional code displayed on a first terminal, starting a browser of the user device, wherein the two-dimensional code includes an address of a relay server of the first terminal; acquiring audio and video information of the user device by means of the browser; sending the audio and video information to the first terminal according to the address of the relay server.

According to the above technical solutions, the method and device for inputting audio and video information have the advantages as follows: the user device is used as the video and audio inputting device on a terminal, and transmission of audio and video information between the user terminal and the terminal is realized on the basis of the relay server technology; therefore, the use cost can be effectively saved, and the requirements of a user for a video resolution and a voice effect can be both met.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow schematic diagram of a method for inputting audio and video information provided by an embodiment of the present disclosure.

FIG. 2 is flow schematic diagram of a method for inputting audio and video information provided by another embodiment of the present disclosure.

FIG. 3 is schematic diagram of a method for inputting audio and video information provided by yet another embodiment of the present disclosure.

FIG. 4 is a structural schematic diagram of a device for inputting audio and video information provided by an embodiment of the present disclosure.

FIG. 5 is a structural schematic diagram of a device for inputting audio and video information provided by another embodiment of the present disclosure.

FIG. 6 is a structural schematic diagram of a network television provided by an embodiment of the present disclosure.

FIG. 7 is a structural schematic diagram of a user device provided by an embodiment of the present disclosure.

### DETAILED DESCRIPTION

In order to make the objectives, technical solutions and advantages of the embodiments of the present disclosure more clear, the technical solutions in the embodiments of the present disclosure will be described below clearly and completely in conjunction with the accompanying drawings in the embodiments of the present disclosure. Apparently, the described embodiments are part, but not all, of the embodiments of the present disclosure. All of other embodiments, obtained by a person of ordinary skill in the art based on the embodiments in the present disclosure without any creative effort should fall into the protection scope of the present disclosure.

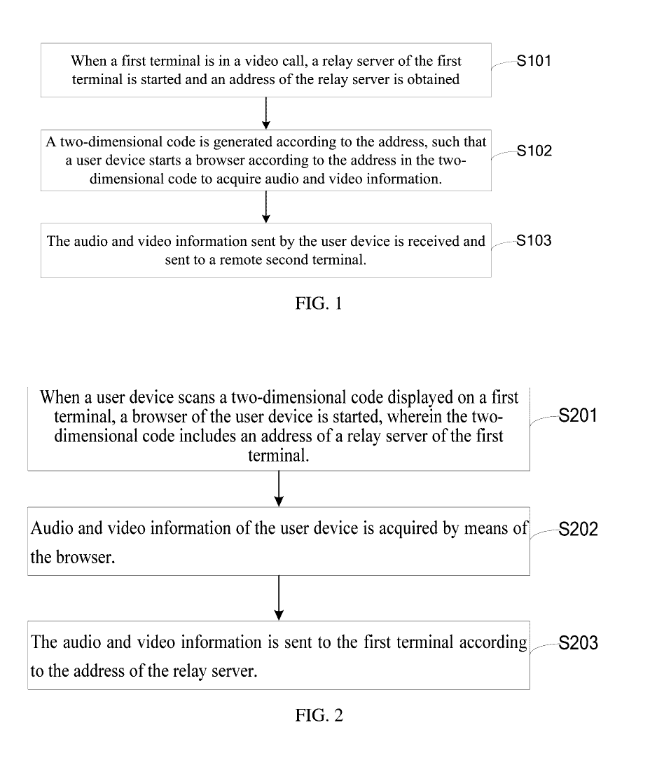

FIG. 1 shows the flow schematic diagram of the method for inputting audio and video information provided by one embodiment of the present disclosure. As shown in FIG. 1, the method includes the following steps:

S101: when a first terminal is in a video call, a relay server of the first terminal is started and an address of the relay server is obtained.

Wherein, the first terminal generally refers to a terminal without camera and microphone, such as a network television, a notebook computer or the like. A user device generally refers to a mobile terminal with a camera and a microphone, like a smart phone, a personal digital assistant (PDA), a tablet computer, a notebook computer or the like. This embodiment is described with examples of the network television serving as the first terminal and the mobile terminal (e.g., a cellphone) serving as the user device. The relay server may be used to realize relay of audio and video data. For instance, a webrtc relay server in the first terminal may be used to relay audio and video data.

For example, when a video call is made by means of the network television, the webrtc relay server in the network television is started, and an intranet address of the server is obtained, like 192.168.0.111:888.

S102: a two-dimensional code is generated according to the address, such that a user device starts a browser according to the address in the two-dimensional code to acquire audio and video information.

For example, the address of the webrtc relay server is converted into a two-dimensional code for displaying on the terminal. After the user device scans the two-dimensional code, the browser is opened according to the address of the webrtc relay server, and the webrtc relay server will establish a webrtc (which is short for Web Real-time Communication) connection with the browser of the user device; moreover, all audio and video data acquired by the user device is transmitted by means of the webrtc connection, wherein webrtc is a technology of real-time data, video and audio communications within a browser.

Further, if the browser is allowed to use the camera and the microphone of the user device, audio and video data of a user can be acquired by means of the browser, and then can be transmitted to the terminal by means of the webrtc connection. In this way, the first terminal can be connected with the user device by means of the webrtc connection as long as they are in the same subnet, without devices such as Bluetooth and the like.

S103, the audio and video information sent by the user device is received and sent to a remote second terminal.

Specifically, the terminal receives the audio and video information sent by the user device by means of a relay server, such as the webrtc relay server, and forwards the audio and video information to the remote terminal. The remote second terminal herein is a terminal in the video call of the first terminal. It thus can be seen that forwarding of the audio and video information can be realized by means of the webrtc relay server in this embodiment.

It needs to be noted that in this embodiment, the user device is used as the audio and video inputting device of the first terminal, and audios and videos of the remote second terminal are output still by means of the screen and the speaker of the second terminal.

It thus can be seen that this embodiment provides the method for inputting audio and video information, in which the user device is used as the audio and video inputting device of the first terminal, and transmission of audio and video information between the user device and the first terminal is realized on the basis of the relay server technology; therefore, no independent peripheral needs to be bought, and the use cost can be effectively saved. Furthermore, the built-in camera and microphone of the user device (e.g., a cellphone) are relatively high in quality; the pixels of a back camera are far more than those of an external common camera, and the audio acquisition quality of the microphone is also far higher than that of a common microphone. As a result, the video resolution and the voice effect both meet the requirements of users.

Specifically, the above step S103 of receiving the audio and video information sent by the user device and sending the audio and video information to the remote second terminal specifically includes the following substeps:

A01: the audio and video information sent by the user device is received by means of the relay server.

For example, the audio and video information sent by the user device may be received by means of the webrtc relay server according to a webrtc protocol. The webrtc relay server will establish the webrtc connection with the browser of the user device, and then the first terminal receives the audio and video information sent by the user device by means of the webrtc relay server on the basis of the webrtc protocol.

A02, the audio and video information is sent to the remote second terminal in the video call by means of the relay server.

For instance, the audio and video information is sent to the remote second terminal in the video call by means of the webrtc relay server.

Hence, during audio and video inputting in this embodiment, the first terminal only serves as a data relay server, i.e., forwarding the video and voice data sent by the user device to the second terminal in the video call.

FIG. 2 shows the flow schematic diagram of the method for inputting audio and video information provided by another embodiment of the present disclosure. As shown in FIG. 2, the method includes the following steps:

S201, when a user device scans a two-dimensional code displayed on a first terminal, a browser of the user device is started, wherein the two-dimensional code includes an address of a relay server of the first terminal.

Specifically, the user device obtains the address of the relay server, like the address of a webrtc relay server, in the first terminal by scanning the two-dimensional code displayed on the first terminal, and further opens the address by means of the browser, such that the first terminal establishes a webrtc connection with the browser of the user device by means of the webrtc relay server.

S202, audio and video information of the user device is acquired by means of the browser.

Specifically, the audio and video information of the user device is acquired using a relay server component built in the browser. For example, the built-in webrtc component of the browser is further used to acquire the data of the camera and the microphone of the user device to obtain the audio and video information.

S203: the audio and video information is sent to the first terminal according to the address of the relay server.

Specifically, step 203 in which the audio and video information is sent to the first terminal according to the address of the relay server specifically includes the following substeps:

B01: a connection between the first terminal and the browser of the user device is established according to the address of the relay server.

For example, the webrtc connection between the first terminal and the browser of the user device is established according to the address of the webrtc relay server.

B02: the audio and video information is sent to the relay server in the first terminal by means of the browser on the basis of the connection, such that the relay server sends the audio and video information to the remote second terminal.

Further, on the basis of the webrtc connection, the audio and video information is sent to the webrtc relay server of the first terminal by means of the browser, such that the webrtc relay server sends the audio and video information to the remote second terminal.

Specifically, WebRTC is composed of three parts: MediaStream, including local audio and video streams or audio and video streams from a remote browser, PeerConnection, used for performing audio and video calling, and supporting encryption and bandwidth control, and DataChannel, employing point-to-point transmission and used for transmitting conventional data.

Accordingly, in step B02, the specific implementation process of sending the audio and video information to the relay server in the first terminal by means of the browser may be as follows: the browser sends the audio and video information to the webrtc relay server of the first terminal by means of the DataChannel.

Hence, in this embodiment, when the first terminal and the second terminal are in a video call, the user device is used as the audio and video information inputting device of the first terminal; moreover, when the user device acquires audio and video information by means of the camera and the microphone, only the browser of the user device needs to be used to realize control on the microphone and the camera and acquisition of audio and video data, and no extra app (Application) needs to be installed. In this way, it results in that the method for inputting audio and video information is simpler and faster, and the labor cost of software development and the like is saved.

It needs to be noted that the method may also include the following step before step S202:

the browser is allowed to use the camera and the microphone of the user device according to a user instruction.

Accordingly, according to a user instruction, the browser may also be prohibited to use the camera and the microphone of the user device.

Hence, before acquiring the audio and video information of the user device by means of the browser, it also requires that the browser is allowed by a user to use the camera and the microphone of the user device; therefore, the safety of the user device in use is improved, and leakage of private information is prevented.

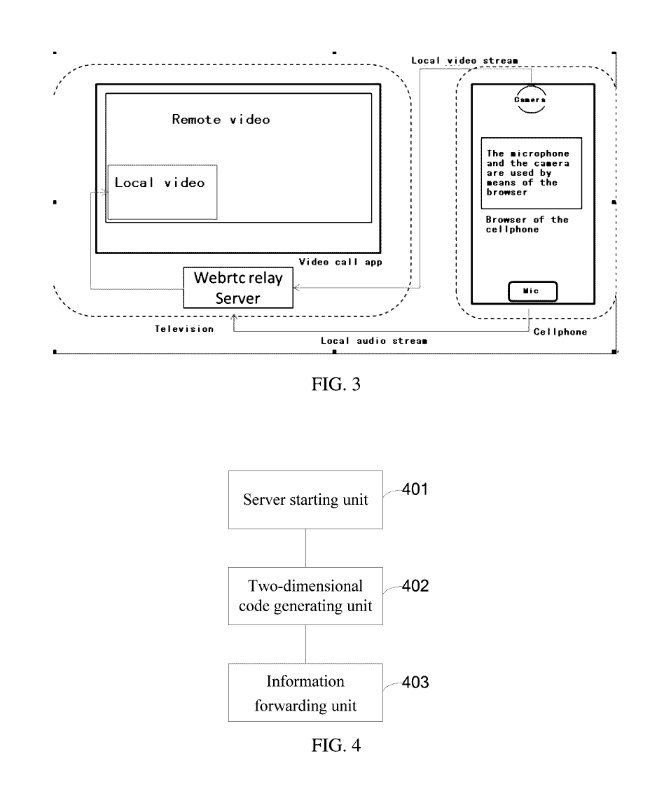

In order to more clearly illustrate the technical solution of the present disclosure, the method for inputting audio and video information will be described below with a specific embodiment. In this embodiment, by taking interaction between a network television and a cellphone as an example, the network television is the first terminal in the above embodiments, while the cellphone is the user device in the above embodiments. FIG. 3 shows the schematic diagram of the method for inputting audio and video information.

As shown in FIG. 3, when the network television is in a video call with a remote terminal, the cellphone serves as an audio and video inputting device for local videos.

Specifically, when the video call app of the network television is started, the webrtc relay server of the television is started; the server will use an intranet address, like 192.168.0.111:8888. The webrtc relay server will establish the webrtc connection (i.e., peerconnect) with the browser of the cellphone, and all the audio and video data of the cellphone will be transmitted through the peerconnect.

Further, the above intranet address is converted into a two-dimensional code for displaying on the screen of the television, such that the cellphone scans the two-dimensional code for access. After the cellphone scans the two-dimensional code, the browser is started according to the intranet address, and the camera and the microphone of the cellphone are used by means of the browser; video data is obtained by means of the camera, while audio data is obtained by means of the microphone, and the video data and the audio data are sent to the network television.

Further, the webrtc relay server in the network television receives the audio and vide data streams sent by the browser of the cellphone by means of the webrtc protocol, thereby displaying the audio and video information in the local video of the network television. Meanwhile, the webrtc relay server forwards the above audio and video streams to the remote side in the video call in one way.

It thus can be seen that in this embodiment, the cellphone serves as the video and audio inputting device for the network television, and transmission of audio and video information between the cellphone and the network television is realized on the basis of the webrtc technology; therefore, the use cost can be effectively saved. Furthermore, as the video resolution and the voice effect of the cellphone are both high, user's requirements can be met.

FIG. 4 shows the structural schematic diagram of the device for inputting audio and video information provided by one embodiment of the present disclosure. As shown in FIG. 4, the device includes: a server starting unit 401, a two-dimensional code generating unit 402 and an information forwarding unit 403, wherein

the server starting unit 401 is configured to start a relay server of a terminal and obtain an address of the relay server when the terminal is in a video call;

the two-dimensional code generating unit 402 is configured to generate a two-dimensional code according to the address, such that a user device starts a browser according to the address in the two-dimensional code to acquire audio and video information;

the information forwarding unit 403 is configured to receive the audio and video information sent by the user device and send the audio and video information to a remote terminal.

Wherein, the information forwarding unit 403 is specifically configured to:

receive the audio and video information sent by the user device by means of the relay server;

send the audio and video information to the remote terminal in the video call by means of the relay server.

The device for inputting audio and video information of this embodiment can be used to execute the method described in above first embodiment, and is similar to the method in principle and technical effects, which are not redundantly described herein.

Another embodiment of the present disclosure provides a network television, including the device for inputting audio and video information which includes the server starting unit 401, the two-dimensional code generating unit 402 and the information forwarding unit 403 in the above embodiment.

Since the network television in this embodiment includes the device for inputting audio and video information, the user device is used as the audio and video inputting device for the network television in this embodiment, and transmission of audio and video information between the user device and the network television is realized on the basis of the relay server (e.g., webrtc) technology; therefore, no independent peripheral needs to be bought, and the use cost can be effectively saved. Furthermore, the built-in camera and microphone of the user device (e.g., a cellphone) are relatively high in quality; the pixels of a back camera are far more than those of an external common camera, and the audio acquisition quality of the microphone is also far higher than that of a common microphone. As a result, the video resolution and the voice effect of the network television both meet the requirements of users.

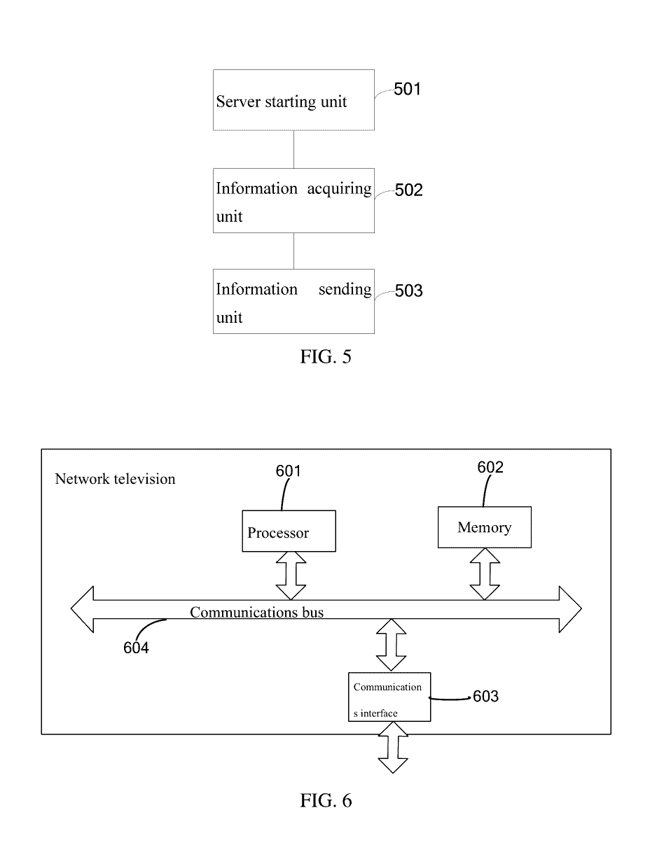

FIG. 5 shows the structural schematic diagram of the device for inputting audio and video information provided by another embodiment of the present disclosure. As shown in FIG. 5, the device includes: a browser starting unit 501, an information acquiring unit 502 and an information sending unit 503, wherein

the browser starting unit 501 is configured to start a browser of a user device when the user device scans a two-dimensional code displayed on a terminal, wherein the two-dimensional code includes an address of a relay server of the terminal;

the information acquiring unit 502 is configured to acquire audio and video information of the user device by means of the browser;

the information sending unit 503 is configured to send the audio and video information to the terminal according to the address of the relay server.

In this embodiment, the device further includes an access controlling unit configured to:

allow the browser to use a camera and a microphone of the user device according to a user instruction

Wherein, the information acquiring unit 502 is specifically configured to:

acquire data of the camera and the microphone of the user device by means of a relay server component in the browser to obtain the audio and video information.

Wherein, the information sending unit 503 is specifically configured to:

establish a connection between the first terminal and the browser of the user device according to the address of the relay server;

send the audio and video information to the relay server by means of the browser on the basis of the connection, such that the relay server sends the audio and video information to the remote terminal.

The device for inputting audio and video information of this embodiment can be used to execute the method described in above second embodiment, and is similar to the method in principle and technical effects, which are not redundantly described herein.

Another embodiment of the present disclosure provides a user device, including the device for inputting audio and video information that includes the browser starting unit 501, the information acquiring unit 502 and the information sending unit 503 in the above embodiment.

The user device of this embodiment includes the above device for inputting audio and video information, and thus can be used as the audio and video information inputting device of the first terminal. Furthermore, when the user device acquires audio and video information by means of the camera and the microphone, only the browser of the user device needs to be used to realize control on the microphone and the camera and acquisition of audio and video data, and no extra app (Application) needs to be installed. In this way, it results in that the method for inputting audio and video information is simpler and faster, and the labor cost of software development and the like is saved.

FIG. 6 shows the structural block diagram of the network television provided by another embodiment of the present disclosure.

By referring to FIG. 6, the network television includes:

a processor 601, a memory 602, a communications interface 603 and a bus 604, wherein

the processor 601, the memory 602 and the communications interface 603 implement communications with each other by means of the bus 604;

the communications interface 603 is used for transmitting information between the network television and a user device;

the processor 601 is used for calling logical instructions in the memory 602 to execute the following method:

when the network television is in a video call, starting a relay server of the network television and obtaining an address of the relay server; generating a two-dimensional code according to the address, such that the user device starts a browser according to the address in the two-dimensional code to acquire audio and video information; receiving the audio and video information sent by the user device and sending the audio and video information to a remote second terminal.

By referring to FIG. 1, another embodiment of the present disclosure discloses a computer program, including program codes for executing the following operations:

when a first terminal is in a video call, starting a relay server of the first terminal and obtaining an address of the relay server;

generating a two-dimensional code according to the address, such that a user device starts a browser according to the address in the two-dimensional code to acquire audio and video information;

receiving the audio and video information sent by the user device and sending the audio and video information to a remote second terminal.

Another embodiment of the present disclosure discloses a storage medium, used to store the computer program as described in the above embodiment.

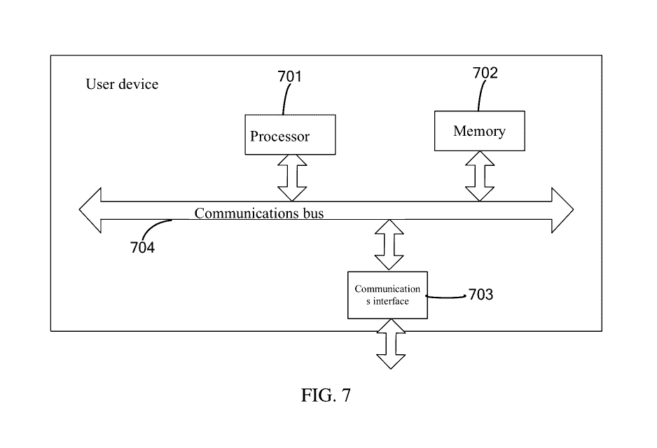

FIG. 7 shows the structural block diagram of the network television of another embodiment of the present disclosure.

By referring to FIG. 7, the network television includes:

a processor 701, a memory 702, a communications interface 703 and a bus 704, wherein

the processor 701, the memory 702 and the communications interface 703 implement communications with each other by means of the bus 704;

the communications interface 703 is used for transmitting information between the user device and a network television;

the processor 701 is used for calling logical instructions in the memory 702 to execute the following method:

while scanning a two-dimensional code displayed on a first terminal, starting a browser of the user device, wherein the two-dimensional code includes an address of a relay server of the first terminal; acquiring audio and video information of the user device by means of the browser; sending the audio and video information to the first terminal according to the address of the relay server.

By referring to FIG. 2, another embodiment of the present disclosure discloses a computer program, including program codes for executing the following operations:

while scanning a two-dimensional code displayed on a first terminal, starting a browser of a user device, wherein the two-dimensional code includes an address of a relay server of the first terminal;

acquiring audio and video information of the user device by means of the browser;

sending the audio and video information to the first terminal according to the address of the relay server.

FIGS. 5-6 are schematic diagrams of a hardware structure of an electronic device for executing a processing method of list item operations provided by the embodiments of the disclosure. The device includes: one or more processors and a memory, with one processor as an example in FIGS. 5-6.

The device for executing a processing method of list item operations provided by the embodiments of the disclosure may also include: an input device and an output device.

As a non-volatile computer-readable storage medium, the memory is available for storing non-volatile software programs, non-volatile computer-executable programs and modules, such as program instructions/modules corresponding to the processing method of list item operations in the embodiments of the present disclosure. By running non-volatile software programs, instructions and modules stored in the memory, the processor executes various function applications and data processing of a server, i.e., achieving the processing method of list item operations in the above method embodiments.

The memory may include a program storage region and a data storage region, wherein the program storage region is available for storing an operating system, and at least one functionally required application; the data storage region is available for storing data created according to the use of a processing device of list item operations, and the like. In addition, the memory may include a high-speed random access memory, and may also include a non-volatile memory, such as at least one magnetic disk storage device, a flash memory device, or other non-volatile solid-state storage devices. In some embodiments, the memory optionally includes memories remotely set with respect to the processor; these remote memories are connectable to the processing device of list item operations by means of networks. Examples of the networks include, but are not limited to, Internet, Intranet, LAN, mobile communication networks and combinations thereof.

The input device is capable of receiving input digit or character information, and producing key signal inputs related to user settings and function control of the processing device of list item operations. The output device may include a display device such as a display screen.

The one or more modules are stored in the memory, and execute the processing method of list item operations in any above method embodiment when executed by the one or more processors.

The products described above are capable of executing the method provided by the embodiments of the present disclosure, and has corresponding function modules for executing the method and beneficial effects. Those technical details not described in detail in the present embodiment may be found in the method provided by the embodiments of the present disclosure.

The electronic device provided by this embodiment of the present disclosure may be present in a plurality of forms, including but not limited to:
(1) Mobile communication equipment: such equipment is characterized by mobile communication functions and mainly intended to provide voice and data communications. Terminals of this type include: smart phones (e.g., iPhone), multimedia mobile phones, functional mobile phones, low-end mobile phones and so on.
(2) Ultra-mobile personal computer equipment: such equipment falls into the category of personal computers, has computing and processing functions, and generally also has a mobile network access characteristic. Terminals of this type include: PDA, MID, UMPC equipment, and the like, for example iPad.
(3) Portable entertainment equipment: such equipment is able to display and play multimedia contents, and includes: audio and video players (e.g., iPod), handheld game players, electronic book readers, and smart toys and portable vehicle-mounted navigation equipment.
(4) Servers: they are equipment providing computing service. Components of a server include a processor, a hard disk, a memory, a system bus and the like. The architecture of a server is similar to that of a general-purpose computer; however, since servers are required to provide highly reliable services, requirements in such aspects as processing ability, stability, reliability, safety, extendibility and manageability are relatively high.
(5) Other electronic devices having the function of data interaction.

The embodiment of the present disclosure provides a non-volatile computer storage medium on which computer-executable instructions available for executing the processing method of list item operations in any method embodiment described above are stored, wherein the storage medium can be a magnetic disk, an optical disk, a read-only memory (ROM), a random access memory (RAM) or the like.

The device embodiments described above are merely schematic, in which units described as separate parts may be or may be not physically separated from one another, and parts displayed as units may be or may be not physical units, i.e., may be located at one place or distributed to a plurality of network units. Part or all of the modules therein may be selected according to actual requirements to achieve the objectives of the solutions in the present embodiment.

According to the above description of the embodiments, a person skilled in the art can clearly understand that various embodiments may be implemented by means of software in combination with a necessary general-purpose hardware platform, and of course, may also be implemented by means of hardware. Based on such understanding, the above technical solutions substantially or the parts making a contribution to the prior art may be embodied in the form of a software product, which can be stored in a computer-readable storage medium, such as an ROM/RAM, a magnetic disk, an optical disk or the like, and which includes a plurality of instructions for causing a computer device (which can be a personal computer, a server, a network device or the like) to execute various embodiments or the method described in some parts of the embodiments.

Finally, it should be noted that the above embodiments are merely intended to illustrate, rather than limit, the technical solutions of the embodiments of the present disclosure. Although the embodiments of the present disclosure are illustrated in detail with reference to the aforementioned embodiments, a person of ordinary skill in the art should understand that modifications may still be made to the technical solutions recorded in the aforementioned embodiments or equivalent substitutions may be made to part or all of technical features therein; these modifications and substitutions do not cause the nature of the corresponding technical solutions to depart from the scope of the technical solutions in the embodiments of the present disclosure.

What is claimed is:

1. A method for inputting audio and video information, comprising:
when a first terminal is in a video call, starting a relay server of the first terminal and obtaining an address of the relay server;
generating a two-dimensional code according to the address, such that a user device starts a browser according to the address in the two-dimensional code to acquire audio and video information;
receiving the audio and video information sent by the user device and sending the audio and video information to a remote second terminal.

2. The method according to claim 1, wherein the step of receiving the audio and video information sent by the user device and sending the audio and video information to the remote second terminal comprises:
receiving the audio and video information sent by the user device by means of the relay server;
sending the audio and video information to the remote second terminal in the video call by means of the relay server.

3. A method for inputting audio and video information, comprising:
when a user device scans a two-dimensional code displayed on a first terminal, starting a browser of the user device, wherein the two-dimensional code comprises an address of a relay server of the first terminal;
acquiring audio and video information of the user device by means of the browser;
sending the audio and video information to the first terminal according to the address of the relay server.

4. The method according to claim 3, before acquiring the audio and video information of the user device by means of the browser, further comprising:
allowing the browser to use a camera and a microphone of the user device according to a user instruction.

5. The method according to claim 4, wherein the step of acquiring the audio and video information of the user device by means of the browser comprises:
acquiring data of the camera and the microphone of the user device by means of a relay server component in the browser to obtain the audio and video information.

6. The method according to claim 3, wherein the step of sending the audio and video information to the first terminal according to the address of the relay server comprises:
establishing a connection between the first terminal and the browser of the user device according to the address of the relay server;
sending the audio and video information to the relay server by means of the browser on the basis of the connection, such that the relay server sends the audio and video information to the remote second terminal.

7. An electronic device, comprising:
at least one processor; and
a memory communicably connected with the at least one processor for storing instructions executable by the at least one processor, wherein execution of the instructions by the at least one processor causes the at least one processor to:
start a relay server of a first terminal and obtain an address of the relay server when the first terminal is in a video call;
generate a two-dimensional code according to the address, such that a user device starts a browser according to the address in the two-dimensional code to acquire audio and video information;
receive the audio and video information sent by the user device and send the audio and video information to a remote second terminal.

8. The device according to claim 7, the processor is further configured to:
receive the audio and video information sent by the user device by means of the relay server;
send the audio and video information to the remote second terminal in the video call by means of the relay server.

9. An electronic device, comprising:
at least one processor; and
a memory communicably connected with the at least one processor for storing instructions executable by the at least one processor, wherein execution of the instructions by the at least one processor causes the at least one processor to:
start a browser of a user device when the user device scans a two-dimensional code displayed on a first terminal, wherein the two-dimensional code comprises an address of a relay server of the first terminal;
acquire audio and video information of the user device by means of the browser;
send the audio and video information to the first terminal according to the address of the relay server.

10. The device according to claim 9, the processor is further configured to:
allow the browser to use a camera and a microphone of the user device according to a user instruction.

11. The device according to claim 10, the processor is further configured to:
acquire data of the camera and the microphone of the user device by means of a relay server component in the browser to obtain the audio and video information.

12. The device according to claim 9, the processor is further configured to:
establish a connection between the first terminal and the browser of the user device according to the address of the relay server;
send the audio and video information to the relay server by means of the browser on the basis of the connection, such that the relay server sends the audio and video information to the remote second terminal.

13. A non-transitory computer-readable storage medium storing executable instructions that, when executed by an electronic device with a touch-sensitive display, cause the electronic device to:
start a relay server of a first terminal and obtain an address of the relay server when the first terminal is in a video call;
generate a two-dimensional code according to the address, such that a user device starts a browser according to the address in the two-dimensional code to acquire audio and video information;
receive the audio and video information sent by the user device and send the audio and video information to a remote second terminal.

14. The non-transitory computer-readable storage medium according to claim 13, the electronic device is further configured to:
receive the audio and video information sent by the user device by means of the relay server;
send the audio and video information to the remote second terminal in the video call by means of the relay server.

15. A non-transitory computer-readable storage medium storing executable instructions that, when executed by an electronic device with a touch-sensitive display, cause the electronic device to:
start a browser of a user device when the user device scans a two-dimensional code displayed on a first terminal, wherein the two-dimensional code comprises an address of a relay server of the first terminal;
acquire audio and video information of the user device by means of the browser;
send the audio and video information to the first terminal according to the address of the relay server.

16. The non-transitory computer-readable storage medium according to claim 15, the electronic device is further configured to:
allow the browser to use a camera and a microphone of the user device according to a user instruction.

17. The non-transitory computer-readable storage medium according to claim 16, the electronic device is further configured to:
acquire data of the camera and the microphone of the user device by means of a relay server component in the browser to obtain the audio and video information.

18. The non-transitory computer-readable storage medium according to claim 15, the electronic device is further configured to:
establish a connection between the first terminal and the browser of the user device according to the address of the relay server;
send the audio and video information to the relay server by means of the browser on the basis of the connection, such that the relay server sends the audio and video information to the remote second terminal.
